(19) United States
(12) Patent Application Publication
(10) Pub. No.: US 2014/0021644 A1
(43) Pub. Date: Jan. 23, 2014

(54) Dies and Methods for Improving Physical Properties of Stretch Film

(71) Applicant: Paragon Films, Inc., Broken Arrow, OK (US)

(72) Inventors: Michael John Baab, Tulsa, OK (US); Shaun Eugene Pirtle, Coweta, OK (US)

(21) Appl. No.: 13/944,475

(22) Filed: Jul. 17, 2013

Related U.S. Application Data
(60) Provisional application No. 61/812,771, filed on Apr. 17, 2013.
(60) Provisional application No. 61/672,585, filed on Jul. 17, 2012.

(51) Int. Cl. B29D 7/01

(52) U.S. Cl. CPC B29D 7/01
USPC 264/40.1; 425/376.1; 425/72.1

(57) ABSTRACT

Dies and methods of extruding stretch film are provided, wherein the die includes at least an upper die lip and a lower die lip; the upper and lower die lips at least partially define a die gap; and at least one of the die lips includes a channel. Another die disclosed includes at least a die gap; and at least one jet for directing a stream of air onto the polymer as it is extruded through the die gap. Stretch films and methods for extruding stretch films are provided, wherein selected areas of the polymer extruded through the die have a gauge that exceeds the film's base gauge. The film includes at least a layer of film having a base gauge and a plurality of strength bands running longitudinally along a length of the film; and have a gauge that is greater than the base gauge.

### STATEMENT OF RELATED CASES

The present application claims the benefit of prior U.S. provisional application 61/672,585, filed on Jul. 17, 2012, and prior U.S. provisional application 61/812,771, filed on Apr. 17, 2013.

### FIELD OF THE INVENTION

The present invention relates generally to devices, systems, and methods for producing stretch films. In certain non-limiting example embodiments, the invention relates to stretch films and methods for producing stretch films wherein thickened bands and folds are introduced into the film in the direction of the stretching.

### BACKGROUND OF THE INVENTION

Stretch films are widely used in a variety of bundling and packaging applications. Machine films are a common method for securing bulky loads such as boxes, merchandise, produce, equipment, parts, and other similar items on pallets. Such films are often made from various polyolefin polymers and are single or multi-layered products.

The ability of a stretch film to secure a load to a pallet and prevent the load from shifting, deforming, and falling apart is dependent on several variables, including the gauge (i.e., thickness) of the film, the amount the film is stretched or oriented prior to being wrapped around the load, the amount of force applied to the film as it is being wrapped around the load, the number of layers of film being applied to the load, and the inherent properties of the film. Load retention or load holding force is one of the most significant and important properties of a stretch film. As the load holding force of the film is decreased, the chance of the load shifting, deforming, and falling apart is increased.

One issue with conventional stretch films is that the edges of the film are easily damaged, which results in tearing or failure of the film during use. Currently in the art, the edges of the film are prepared by transversely slitting individual roll widths of film from a wider width of film by means of a conventional sharp edge slitter assembly. Any defects that are introduced into the edges of the film during the slitting process can result in film failure as the film is wrapped around a load. Dropping the film roll or any other abuse during handling creates zones of weakness or tears in the edges of the film.

Currently, in order to minimize the weight of the film and decrease the price and time required to wrap a load, the gauge of the film and/or the number of wraps applied to the load is reduced, and/or the stretch level of the film is increased. However, if the gauge of the film and/or the number of wraps applied to the load is decreased, the film's inherent properties, such as load holding force, must be improved.

Increasing the overall thickness of the edge can result in a film that is easier to use and reduces waste by making the film less susceptible to failure due to tears, rough handling, or excessive stretching. However, the current methods of increasing edge thickness require a secondary process of introducing a fold or adding a laminated film, which increases the time and cost of film production. The secondary process also requires monitoring due to the issues of fabrication changes, film quality, and maintenance.

Another issue with conventional stretch film is the lack of resistance to tear propagation in the film after a defect has been initiated. Most conventional stretch films that have been applied under a moderate to high load containment force will continue to propagate a tear once the initial defect has occurred. This leads to a decrease in load containment force, up to and including complete film failure. Current methods to address this problem include supplementing the film with separate laminate or adhesive strips. However, this method requires a secondary process, with a corresponding increase in the complexity, time, and cost of film production.

Another method known in the art for increasing the load holding force of a stretch film includes utilizing higher performance resins and polymers, which permits the film to be produced at reduced gauges and to be stretched further before failing. The main issues associated with these methods include the increased cost of the higher performance resin(s) and polymers, and the fact that the thinner the film is and the more it is stretched, the more likely it is to fail during the application process.

Another issue with conventional stretch film is the lack of load containment, especially for thin gauge (i.e., less than 16 microns) products. Load containment is the ability of the film to properly unitize and maintain a stable product configuration without failure or significant stretching and relaxation. In addition to load containment, most customers recognize the value of stretch film as a dust cover for their products and as protection against tampering. However, current technology requires that the entire width of the film be thick enough to produce the required load containment force. Alternatively, laminate or adhesive strips or folds are added to the film in a secondary process. As a result, more polymer is used than is strictly necessary to achieve the dual purposes of load containment and protection from dust and tampering. This wastes polymer that could be used to make additional film or other products, decreases efficiency, and increases costs associated with making, transporting, and using stretch films. However, making the overall film thinner would reduce the load containment force along with increasing the potential for tear propagation and film breakage.

There is, therefore, a long-standing yet unmet need for improved stretch films which allow a load to be unitized in a more cost and time efficient manner, without sacrificing the integrity of the stretch film. There is a further unmet need for methods of producing such improved stretch films.

### SUMMARY OF THE INVENTION

Dies and methods of extruding stretch film are provided, in which the die includes at least an upper die lip and a lower die lip; the upper and lower die lips at least partially define a die gap; and at least one of the die lips includes a channel. Another die disclosed includes at least a die gap; and at least one jet for directing a stream of air onto the polymer as it is extruded through the die gap.

A variety of methods for extruding stretch film are also disclosed, wherein selected areas of the polymer extruded through the die have a gauge that exceeds the film's base gauge. Stretch films are also disclosed, wherein the film includes at least a layer of film having a base gauge and a plurality of strength bands; wherein the bands run longitudinally along a length of the film and have a gauge that is greater than the base gauge; and are separated from each other by discrete intervals across a width of the film.

### BRIEF DESCRIPTION OF THE DRAWINGS

For a further understanding of the nature, objects, and advantages of the present invention, reference should be had to the followed description, read in conjunction with the following drawings, wherein like reference numerals denote like elements and wherein:

FIG. 1 illustrates a means for producing a film from molten polymers, according to an example embodiment disclosed herein;

FIG. 2 illustrates the view of an upper and lower die lip from a conventional flat die as known in the prior art;

FIG. 3 illustrates the die lips according to an example embodiment;

FIG. 4 illustrates an alternate embodiment, wherein the channels on opposite die lips are directly across from each other;

FIG. 5 illustrates an alternate embodiment, wherein the channels on opposite die lips are offset from each other;

FIG. 6 illustrates the film web as extruded from the die of FIG. 3; and

FIG. 7 illustrates a cross-sectional view of the film after the film has been slit and the center bleed trim has been removed.

### DETAILED DESCRIPTION

The following description is not to be taken in a limiting sense, but is made merely for the purpose of illustrating example embodiments. In particular embodiments, a device for incorporating thickened areas (i.e., strength bands or bands) into the film web in situ is used, resulting in a film that is less susceptible to edge damage, has improved load containment force, and is able to mitigate tear propagation. According to further example embodiments, the device allows for multiple strength bands in a single width of film, multiple strength bands on opposite sides of the film that are directly across from each other, and multiple strength bands on opposite sides of the film that are offset from each other. In still further embodiments, the device also allows for strength bands in multiple locations across a wider width of film, which allows for simultaneous formation of multiple film rolls from a single sheet of film.

In still further example embodiments, a die is provided, which has a die lip with at least one channel that forms a die gap that is deeper than a die gap formed by a remainder of the die lip. As the molten polymer is extruded from the die, the film web associated with the channel is thicker than the rest of the web, forming a strength band that runs along the length of the film in the machine direction. Alternatively, according to example embodiments, the strength bands are formed with cooling jets, placed near the die gap between die lips and spaced along the length of the die lip, that direct cool air onto the polymer as it is extruded from the die.

According to other example embodiments, methods for making a film having one or more strength bands are provided. In alternative embodiments, the method includes the steps of heating a polymer to a molten condition in an extruder, delivering the polymer through a transfer pipe to a die with a die lip, and extruding the polymer through the die onto a casting roll. The die lip has at least one channel that forms a deeper die gap, which allows an increased volume of polymer to flow through the channel to form the band. Alternatively, the die lip has at least one jet that forms the band by directing a stream of cool air onto the polymer as it is extruded from the die.

According to example embodiments, the load holding force of the stretch film is increased. In further embodiments, the strength bands run along the length of the film, in the machine direction of the film. According to example embodiments, the strength bands increase the cross-sectional area of the film in the specific regions where the strength bands are incorporated.

According to still other example embodiments, the sections of the film without the strength bands are thinner than a traditional film of uniform thickness, while the average weight of the film with strength bands is the same as or less than a film with uniform thickness.

In still further alternative embodiments, folds are incorporated into the stretch film. In further embodiments, the addition of the folds in the film results in an increase of the cross-sectional area of the film in the specific regions where the folds are added, while the average weight of the film with folds is the same as or less than a traditional film with uniform thickness.

According to further example embodiments, the use of strength bands and folds in the film web results in being able to use a thinner gauge base film, for the same applications where previously only a thicker film with uniform thickness could be utilized.

According to further example embodiments, the bands and folds are introduced into the film in the direction of stretching (i.e., machine direction), which results in a higher resistance to deformation. Ultimately, the higher resistance to deformation translates into a higher load holding force of the overall film.

In some embodiments, rolls of stretch film are produced in-line.

In certain example embodiments, a method of incorporating folds into the film web is provided. According to example embodiments, multiple slits are cut into the film web, and the edges of the slits are folded. In still further embodiments, the film provides a higher load holding force versus a film with the same initial thickness and/or weight that does not contain slits or folds.

According to still further example embodiments, a stretch film that is comprised of a layer of film having a base gauge and a plurality of strength bands that are an integral part of the film layer is provided. Each band runs in a machine direction along the length of the film and has a gauge that is greater than the base gauge. The bands are spaced across the width of the film at discrete intervals.

According to example embodiments, the strength bands increase load containment force, improve resistance to tear propagation, and reduce film breakage due to edge damage while generally maintaining the same average thickness as a conventional film. For example, the average thickness of a conventional 60-gauge film with a flat profile is 60 gauge. In comparison, according to example embodiments, 80 percent of the film is 50 gauge. According to further embodiments, the strength bands, although comprising only 20 percent of the film, are 100 gauge, giving the embodiment an average thickness of 60 gauge. At the same time, the bands significantly increase load containment force and resistance to tear propagation.

Alternatively, in other embodiments the same load containment force is achieved with less polymer by reallocating some of the polymer from the rest of the film to the bands. The remaining areas of film, although thinner, are sufficient to protect the load from dust and provide evidence of tampering. The gauge of the areas of film other than the bands is referred to herein as the base gauge.

According to one example embodiment, the steps for producing cast stretch film are as follows: producing a film from molten polymers, gauging the film, longitudinally slitting the film into multiple sections, and winding the film onto a film roll. In certain embodiments, the web is oscillated in order to prevent strength bands in the film from stacking upon themselves and producing hard areas in the film roll. In still other alternate embodiments, these steps are performed in a different order. In other example embodiments, one or more steps are eliminated without departing from the scope.

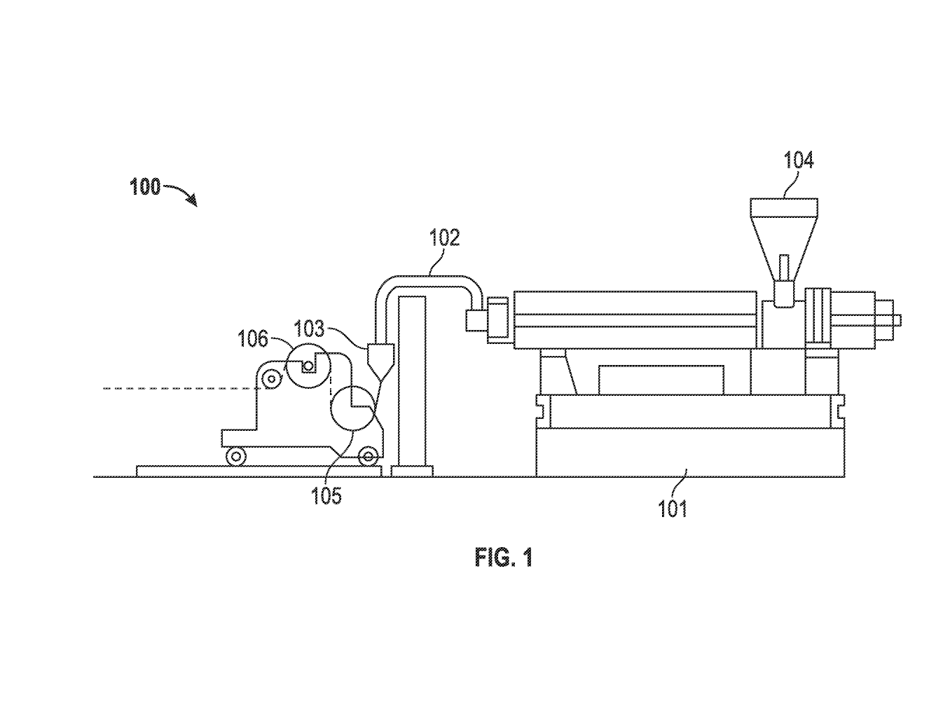

Turning now to FIG. 1, an example embodiment for producing film from molten polymers 100 comprises one or more extruders 101 connected by transfer pipes 102 to a die 103. The extruders 101 are connected to a source 104 of stock polymers. The extruders 101 heat the stock polymers to a molten condition and deliver the molten polymers through the transfer pipes 102 to the die 103. The polymer is then extruded through the die 103 onto a casting roll 105, which, in certain embodiments, is a 30-inch diameter matt casting roll with a set temperature. The film moves from the casting roll 105 to a secondary chill roll 106, which, in certain embodiments, is a 20-inch diameter mirror finish secondary chill roll with a set temperature.

Cast stretch films are generally manufactured with flat cast film dies. Turning now to FIG. 2, illustrated is a flat cast film die 200 according to the prior art. The die includes an upper die lip 201, a lower die lip 202, and a die gap 203 between the upper die lip 201 and lower die lip 202 through which the molten polymer is extruded.

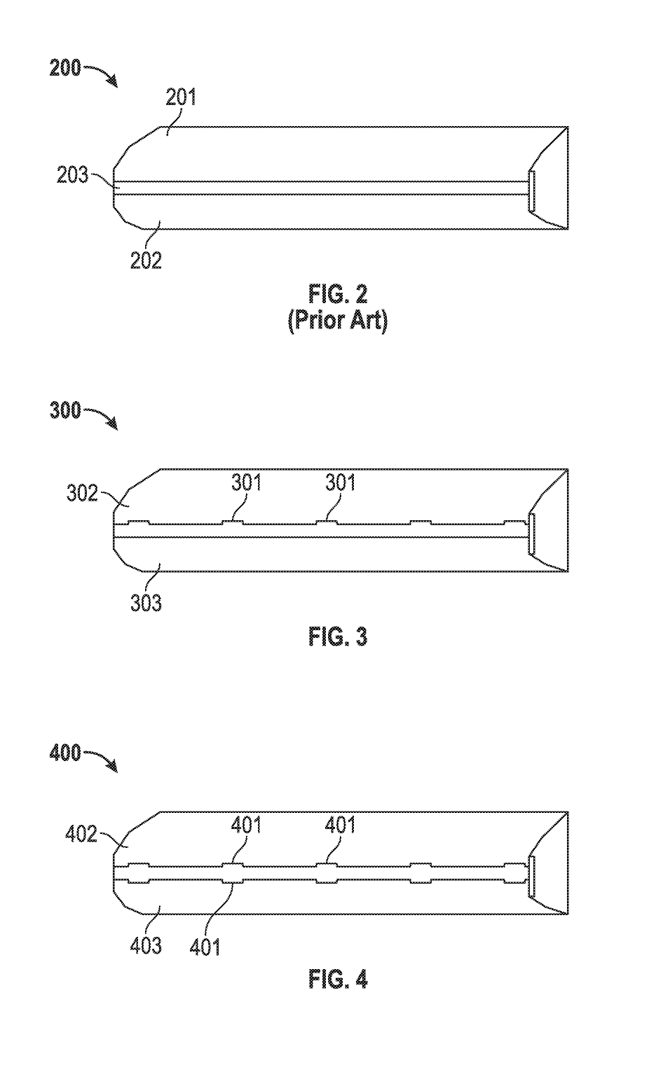

Turning now to FIG. 3, according to example embodiments, one or more channels, grooves, depressions, or relieved areas 301 are cut in the upper die lip 302 of the flat cast film die 300. According to other example embodiments, channels 301 are also cut in the lower die lip 303 or through the die lip and into the die.

According to other alternative embodiments, channels 401 are disposed directly opposite from each other, cut into both the upper die lip 402 and the lower die lip 403 of the flat cast film die 400, as shown in FIG. 4. Such embodiments result in a film with increase load containment force.

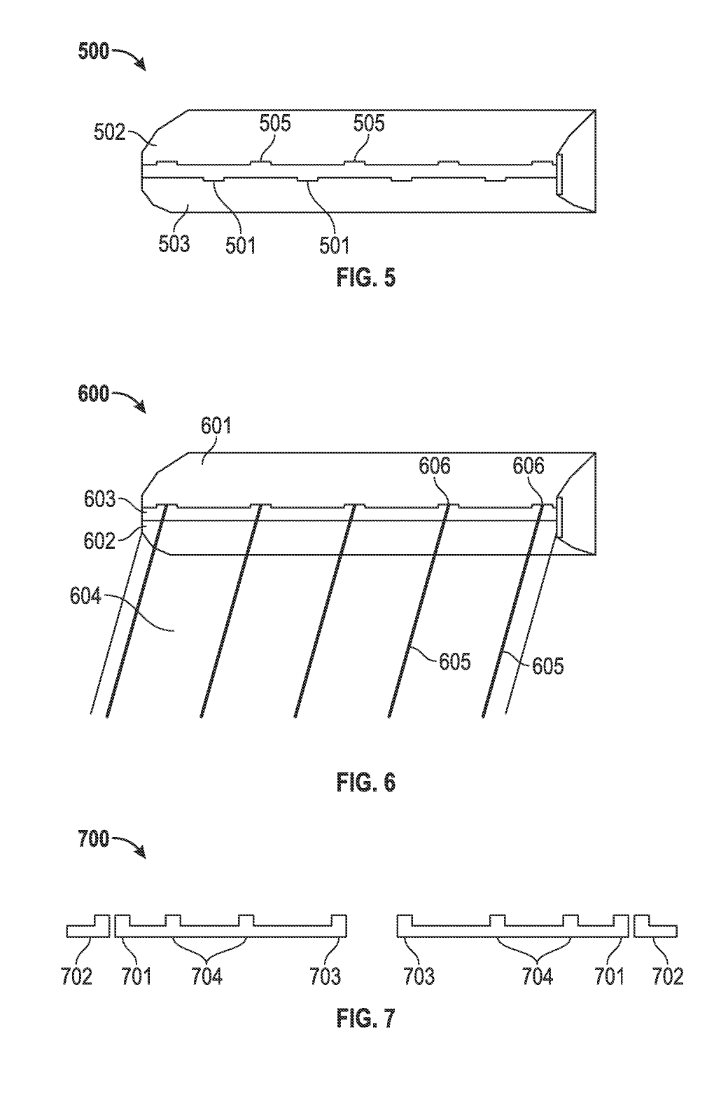

Turning now to FIG. 5, according to still other embodiments, channels 505 cut in the upper die lip 502 and are offset from the channels 501 cut in the lower die lip 503 of the flat cast film die 500, resulting in a film with increased resistance to tear propagation.

According to example embodiments, the channels are spaced from about 2 to about 15 inches apart. According to still further example embodiments, the channels are spaced from about 3 to about 5 inches apart. Each channel is from about 1/128 to about 2 inches wide. According to still other embodiments, each channel is from about ¼ to about ¾ inches wide. In still further example embodiments, each channel is from about 1/50 to about 10 millimeters deep. According to alternative embodiments, each channel is from about 2/10 to about 1 millimeter deep.

Turning now to FIG. 6, according to example embodiments, molten polymer 604 is extruded through the die gap 603 onto the casting roll. Additional polymer 605 is extruded through the channels 606 in the die gap 603, resulting in areas of increased gauge or “bands” running along the length of the film in the machine direction. According to alternative embodiments, the bands are an integral component and form simultaneously with the rest of the film. In example embodiments, the increase in gauge for each band ranges from about 30 to about 500 percent.

According to alternative embodiments, the increase in gauge is about 100 percent. In still other embodiments, the bands are located about ¼, ½. and ¾ of the way across the width of the film.

In further embodiments, channels 604 are spaced at both ends of the upper die lip 601 and at various intervals across the length of the upper die lip 601. This configuration produces strength bands near the edges of the film web and across the width of the film.

Once the film web is formed, according to further example embodiments, it is sent to a slitting assembly. A conventional slitting assembly is used to slit the film web into multiple sections.

According to still other example embodiments, as shown in FIG. 7, the slitting assembly slices through the middle of the bands at the edges of the film 700, forming a thickened edge 701 and edge trim 702 that is recycled to the extruder. According to further example embodiments, the slitting assembly cuts through some of the strength bands inside the film 700, producing thickened edges 703 for adjacent film rolls, as well as center trim (not shown) that is recycled to the extruder. The thickened edges 701, 703 make the film 700 less susceptible to edge failure. The bands 704 between the thickened edges 701, 703 increase the film's load containment force and decrease the potential for tear propagation.

According to further example embodiments, strength bands are formed by jets that direct cool air onto the molten polymer as it is extruded from the die. In a conventional film, the movement of the casting roll reduces or “draws down” the thickness of the polymer as the polymer moves from the die to the casting roll. In an alternative embodiment, jets on the die blow cool air on the molten polymer as it is extruded from the die. As a result, the polymer is fixed in place before it is drawn down by the casting roll, forming thicker areas (i.e., strength bands) within the film web.

In alternative embodiments, the areas of polymer that are not affected by the jets are drawn down and fixed when they contact the casting roll, forming the thinner areas of the film web between the bands. Depending upon the desired characteristics of the film, according to example embodiments, the jets are spaced at different intervals along the die lip, and the flow, velocity, and temperature of the cool air varies.

Other embodiments of the film have strength bands only on the edges of the film, with the remainder of the film having a flat profile. In still other example embodiments, the strength bands are used alone or in conjunction with folded film edges to improve load containment force and resistance to tear propagation.

When compared to a film with a flat profile, example embodiments use the same total amount of polymer, but have increased load containment force, improved resistance to tear propagation, and less susceptibility to failure due to edge damage. In alternative embodiments, the amount of polymer used is less than the amount of polymer that would be used in a conventional film. According to still further embodiments, the strength bands maintain the effective load containment force of the film, as well as improving its resistance to tear propagation and reducing film breakage. In still further embodiments, the gauge of the film in the areas between the bands can be reduced without affecting the film's overall performance. In further embodiments, the thinner areas are sufficient to protect the load from dust and tampering.

According to still further example embodiments, the methods and films disclosed are applied to stretch film with and without folded edges, hand wrap, machine wrap, blown film, cast film, and film with and without air entrapped between the layers of film on the film roll. According to further embodiments, strength bands are formed for blown film by cutting channels in the blown film die lips. In still further embodiments, strength bands are formed for blown film by blowing cold air on the molten polymer of the blown film as it exits the die and before it enters the frost line.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions are also made without departing from the spirit or scope thereof.

1. A die for extruding stretch film, the die comprising:
an upper die lip and a lower die lip, wherein the upper die lip and the lower die lip at least partially define a die gap;
wherein at least one of said die lips further comprises a channel.

2. The die according to claim 1, wherein said upper die lip further comprises at least one channel.

3. The die according to claim 1, wherein said lower die lip further comprises at least one channel.

4. The die according to claim 1, where said lower die lip and said upper die lip both further comprise at least one channel.

5. The die according to claim 4, wherein the channels of the upper die lip are disposed opposite the channels of the lower die lip.

6. The die according to claim 4, wherein the channels of the upper die lip are offset from the channels of the lower die lip.

7. A die for extruding stretch film, the die comprising:
a die gap through which molten polymer is extruded; and
at least one jet for directing a stream of air onto the polymer as it is extruded through the die gap.

8. A method for extruding stretch film, the method comprising:
heating a polymer to a molten condition;
delivering the polymer through a transfer pipe to a die having a die lip comprising at least one channel;
extruding the polymer through the die gap onto a casting roll; and
forming a film wherein the polymer that is extruded through the at least one channel has a gauge that exceeds a base gauge of the film.

9. A method for extruding stretch film, the method comprising:
heating a polymer to a molten condition;
delivering the polymer through a transfer pipe to a die, the die further comprising a die gap;
extruding the polymer through the die gap onto a casting roll;
directing a stream of air onto an area of the polymer as it is extruded from the die gap; and
forming a film wherein the area of the polymer has a gauge that exceeds a base gauge of the film.

10. A stretch film comprising:
a layer of film comprising a base gauge and a plurality of strength bands formed structurally integral therewith, wherein said bands run longitudinally along a length of the film and have a gauge that is greater than the base gauge,
wherein said bands are separated from each other by discrete intervals across a width of the film.
